(19) United States
(12) Patent Application Publication
(10) Pub. No.: US 2005/0126597 A1
(43) Pub. Date: Jun. 16, 2005

(54) Inspection camera

(76) Inventors: James R. Hochstein JR., Seattle, WA (US); Scott A. Flatness, Seattle, WA (US)

Correspondence Address: BACHMAN & LAPOINTE, P.C., 900 CHAPEL STREET, SUITE 1201, NEW HAVEN, CT, 06510, US

(21) Appl. No.: 10/733,606

(22) Filed: Dec. 11, 2003

(51) Int. Cl. B08B 3/02

(52) U.S. Cl. 134/22.1; 134/22.18; 134/24; 134/167 R; 134/172

(57) ABSTRACT

An inspection camera may be used in conjunction with a shockwave cleaning apparatus. The camera has a head held in an operative position within a vessel interior. A light source has at least a light emitting element carried by the head. At least an incident lens of the camera is carried by the head so as to capture light from the source as returned by a surface within the vessel interior.

### BACKGROUND OF THE INVENTION

(1) Field of the Invention

The invention relates to industrial equipment. More particularly, the invention relates to the inspection of industrial equipment subject to detonative cleaning.

(2) Description of the Related Art

Surface fouling is a major problem in industrial equipment. Such equipment includes furnaces (coal, oil, waste, etc.), boilers, gasifiers, reactors, heat exchangers, and the like. Typically the equipment involves a vessel containing internal heat transfer surfaces that are subjected to fouling by accumulating particulate such as soot, ash, minerals and other products and byproducts of combustion, more integrated buildup such as slag and/or fouling, and the like. Such particulate build-up may progressively interfere with plant operation, reducing efficiency and throughput and potentially causing damage. Cleaning of the equipment is therefore highly desirable and is attended by a number of relevant considerations. Often direct access to the fouled surfaces is difficult. Additionally, to maintain revenue it is desirable to minimize industrial equipment downtime and related costs associated with cleaning. A variety of technologies have been proposed. By way of example, various technologies have been proposed in U.S. Pat. Nos. 5,494,004 and 6,438,191 and U.S. patent application publication 2002/0112638. Additional technology is disclosed in Huque, Z. Experimental Investigation of Slag Removal Using Pulse Detonation Wave Technique, DOE/HBCU/OMI Annual Symposium, Miami, Fla., Mar. 16-18, 1999. Particular blast wave techniques are described by Hanjalić and Smajević in their publications: Hanjalić, K. and Smajević, I., Further Experience Using Detonation Waves for Cleaning Boiler Heating Surfaces, International Journal of Energy Research Vol. 17, 583-595 (1993) and Hanjalić, K. and Smajević, I., Detonation-Wave Technique for On-load Deposit Removal from Surfaces Exposed to Fouling: Parts I and II, Journal of Engineering for Gas Turbines and Power, Transactions of the ASME, Vol. 1, 116 223-236, January 1994. Such systems are also discussed in Yugoslav patent publications P 1756/88 and P 1728/88. Such systems are often identified as “soot blowers” after an exemplary application for the technology.

Nevertheless, there remain opportunities for further improvement in the field.

### SUMMARY OF THE INVENTION

One aspect of the invention involves an apparatus for cleaning a surface within a vessel having a vessel wall separating a vessel exterior from a vessel interior and having a wall aperture. An elongate conduit has an upstream first end and a downstream second end and is positioned to direct a shockwave from the second end into the vessel interior. An inspection camera apparatus has a head held in an operative position within the vessel interior, a light source, and a camera. At least a light emitting element of the light source is carried by the head. At least an incident lens of the camera is carried by the head so as to capture light from the source as returned by the surface.

In various implementations, a source of fuel and oxidizer may be coupled to the conduit to deliver the fuel and oxidizer to the conduit. An initiator may be positioned to initiate a reaction of the fuel and oxidizer to produce the shockwave. The camera may be carried essentially within the head. The light source may be carried essentially within the head. The apparatus may include a cooling fluid-carrying support member. The surface may be an exterior surface of at least one tube in a first tube bundle. The support member may extend between the first tube bundle and a second tube bundle. The head may be positioned between first and second tubes of the first tube bundle.

Another aspect of the invention involves an inspection camera apparatus having a head, a light source, a camera, and a support mechanism. The head is held in an operative position within the vessel interior. At least a light emitting element of the light source is carried by the head. At least an incident lens of the camera is carried by the head so as to capture light from the source as returned by the surface. The support mechanism holds the head in an operative position. A cooling fluid flowpath extends at least partially through the support mechanism.

In various implementations, the camera may be a CCD camera. The cooling fluid flowpath may extend around the control member within the guide conduit. The support mechanism may contain lines carrying signal communication from the camera and power to the light source and cooled by the cooling fluid. The apparatus may be used in combination with a detonative cleaning apparatus.

Another aspect of the invention involves a method for cleaning a surface within a vessel of a piece of industrial equipment. The vessel has a wall with an aperture therein. Fuel and oxidizer are introduced to a conduit. A reaction of the fuel and oxidizer is initiated so as to cause a shockwave to impinge upon the surface. A camera is used having an integral light source within the vessel to inspect the surface while the industrial equipment is in operation.

In various implementations, the method may be formed in a repeated sequential way. The camera may be inserted between adjacent first and second tube bundles and then between first and second tubes of the first bundle.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of an industrial furnace associated with several soot blowers positioned to clean a level of the furnace.

FIG. 2 is a side view of one of the blowers of FIG. 1.

FIG. 3 is a partially cut-away side view of an upstream end of the blower of FIG. 2.

FIG. 4 is a longitudinal sectional view of a main combustor segment of the soot blower of FIG. 2.

FIG. 5 is an end view of the segment of FIG. 4.

FIG. 6 is a partially schematic view of an inspection camera system.

FIG. 7 is a side view of a camera head of the system of FIG. 6.

Like reference numbers and designations in the various drawings indicate like elements.

### DETAILED DESCRIPTION

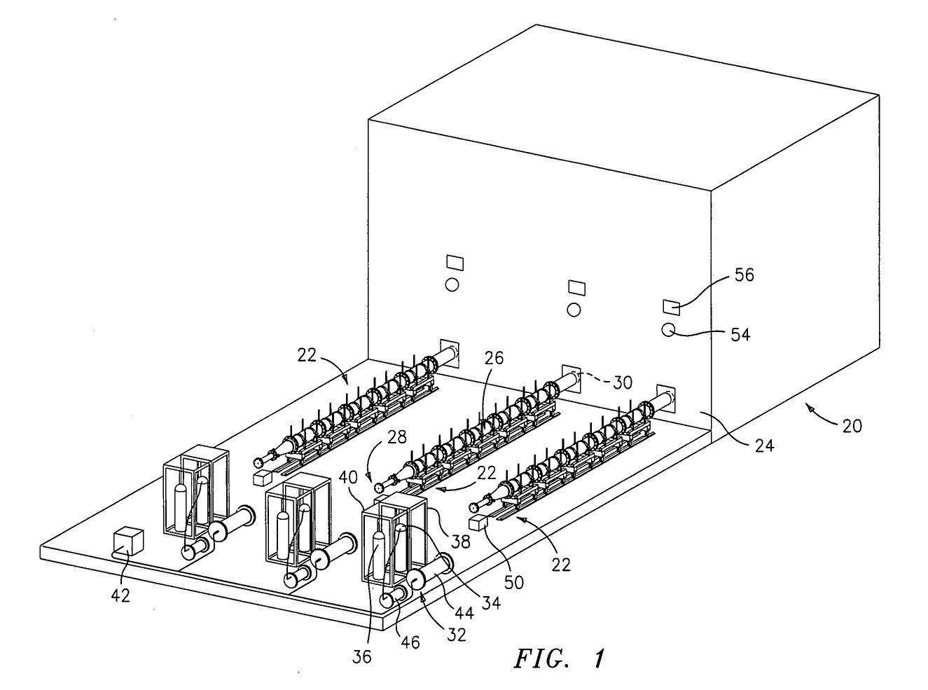

FIG. 1 shows a furnace 20 having an exemplary three associated soot blowers 22. In the illustrated embodiment, the furnace vessel is formed as a right parallelepiped and the soot blowers are all associated with a single common wall 24 of the vessel and are positioned at like height along the wall. Other configurations are possible (e.g., a single soot blower, one or more soot blowers on each of multiple levels, and the like).

Each soot blower 22 includes an elongate combustion conduit 26 extending from an upstream distal end 28 away from the furnace wall 24 to a downstream proximal end 30 closely associated with the wall 24. Optionally, however, the end 30 may be well within the furnace. In operation of each soot blower, combustion of a fuel/oxidizer mixture within the conduit 26 is initiated proximate the upstream end (e.g., within an upstreammost 10% of a conduit length) to produce a detonation wave which is expelled from the downstream end as a shockwave along with associated combustion gases for cleaning surfaces within the interior volume of the furnace. Each soot blower may be associated with a fuel/oxidizer source 32. Such source or one or more components thereof may be shared amongst the various soot blowers. An exemplary source includes a liquified or compressed gaseous fuel cylinder 34 and an oxygen cylinder 36 in respective containment structures 38 and 40. In the exemplary embodiment, the oxidizer is a first oxidizer such as essentially pure oxygen. A second oxidizer may be in the form of shop air delivered from a central air source 42. In the exemplary embodiment, air is stored in an air accumulator 44. Fuel, expanded from that in the cylinder 34 is generally stored in a fuel accumulator 46. Each exemplary source 32 is coupled to the associated conduit 26 by appropriate plumbing below. Similarly, each soot blower includes a spark box 50 for initiating combustion of the fuel oxidizer mixture and which, along with the source 32, is controlled by a control and monitoring system (not shown). FIG. 1 further shows the wall 24 as including a number of ports for inspection and/or measurement. Exemplary ports include an optical monitoring port 54 and a temperature monitoring port 56 associated with each soot blower 22 for respectively receiving an infrared and/or visible light video camera and thermocouple probe for viewing the surfaces to be cleaned and monitoring internal temperatures. Other probes/monitoring/sampling may be utilized, including pressure monitoring, composition sampling, and the like.

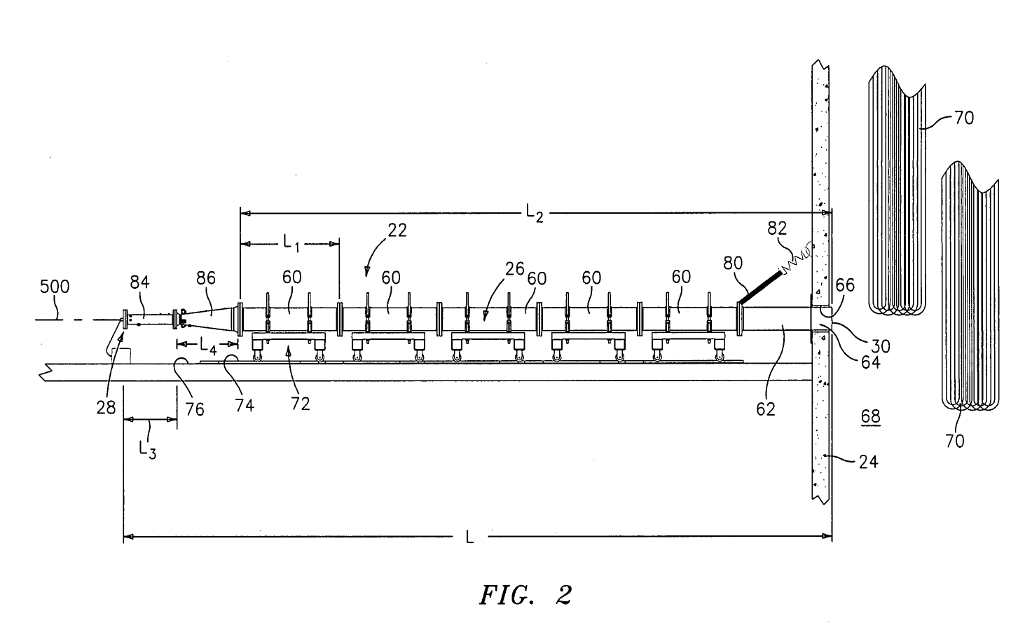

FIG. 2 shows further details of an exemplary soot blower 22. The exemplary detonation conduit 26 is formed with a main body portion formed by a series of doubly flanged conduit sections or segments 60 arrayed from upstream to downstream and a downstream nozzle conduit section or segment 62 having a downstream portion 64 extending through an aperture 66 in the wall and ending in the downstream end or outlet 30 exposed to the furnace interior 68. The term nozzle is used broadly and does not require the presence of any aerodynamic contraction, expansion, or combination thereof. Exemplary conduit segment material is metallic (e.g., stainless steel). The outlet 30 may be located further within the furnace if appropriate support and cooling are provided. FIG. 2 further shows furnace interior tube bundles 70, the exterior surfaces of which are subject to fouling. In the exemplary embodiment, each of the conduit segments 60 is supported on an associated trolley 72, the wheels of which engage a track system 74 along the facility floor 76. The exemplary track system includes a pair of parallel rails engaging concave peripheral surfaces of the trolley wheels. The exemplary segments 60 are of similar length L₁ and are bolted end-to-end by associated arrays of bolts in the bolt holes of their respective flanges. Similarly, the downstream flange of the downstreammost of the segments 60 is bolted to the upstream flange of the nozzle 62. In the exemplary embodiment, a reaction strap 80 (e.g., cotton or thermally/structurally robust synthetic) in series with one or more metal coil reaction springs 82 is coupled to this last mated flange pair and connects the combustion conduit to an environmental structure such as the furnace wall for resiliently absorbing reaction forces associated with discharging of the soot blower and ensuring correct placement of the combustion conduit for subsequent firings. Optionally, additional damping (not shown) may be provided. The reaction strap/spring combination may be formed as a single length or a loop. In the exemplary embodiment, this combined downstream section has an overall length L₂. Alternative resilient recoil absorbing means may include non-metal or non-coil springs or rubber or other elastomeric elements advantageously at least partially elastically deformed in tension, compression, and/or shear, pneumatic recoil absorbers, and the like.

Extending downstream from the upstream end 28 is a predetonator conduit section/segment 84 which also may be doubly flanged and has a length L₃. The predetonator conduit segment 84 has a characteristic internal cross-sectional area (transverse to an axis/centerline 500 of the conduit) which is smaller than a characteristic internal cross-sectional area (e.g., mean, median, mode, or the like) of the downstream portion (60, 62) of the combustion conduit. In an exemplary embodiment involving circular sectioned conduit segments, the predetonator cross-sectional area is a characterized by a diameter of between 8 cm and 12 cm whereas the downstream portion is characterized by a diameter of between 20 cm and 40 cm. Accordingly, exemplary cross-sectional area ratios of the downstream portion to the predetonator segment are between 1:1 and 10:1, more narrowly, 2:1 and 10:1. An overall length L between ends 28 and 30 may be 1-15 m, more narrowly, 5-15 m. In the exemplary embodiment, a transition conduit segment 86 extends between the predetonator segment 84 and the upstreammost segment 60. The segment 86 has upstream and downstream flanges sized to mate with the respective flanges of the segments 84 and 60 has an interior surface which provides a smooth transition between the internal cross-sections thereof. The exemplary segment 86 has a length L₄. An exemplary half angle of divergence of the interior surface of segment 86 is >12°, more narrowly 5-10°.

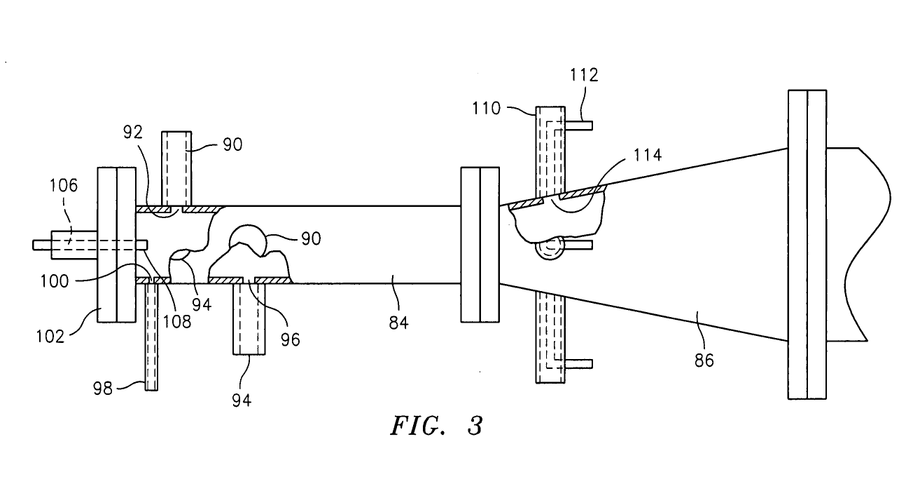

A fuel/oxidizer charge may be introduced to the detonation conduit interior in a variety of ways. There may be one or more distinct fuel/oxidizer mixtures. Such mixture(s) may be premixed external to the detonation conduit, or may be mixed at or subsequent to introduction to the conduit. FIG. 3 shows the segments 84 and 86 configured for distinct introduction of two distinct fuel/oxidizer combinations: a predetonator combination; and a main combination. In the exemplary embodiment, in an upstream portion of the segment 84, a pair of predetonator fuel injection conduits 90 are coupled to ports 92 in the segment wall which define fuel injection ports. Similarly, a pair of predetonator oxidizer conduits 94 are coupled to oxidizer inlet ports 96. In the exemplary embodiment, these ports are in the upstream half of the length of the segment 84. In the exemplary embodiment, each of the fuel injection ports 92 is paired with an associated one of the oxidizer ports 96 at even axial position and at an angle (exemplary 90° shown, although other angles including 180° are possible) to provide opposed jet mixing of fuel and oxidizer. Discussed further below, a purge gas conduit 98 is similarly connected to a purge gas port 100 yet further upstream. An end plate 102 bolted to the upstream flange of the segment 84 seals the upstream end of the combustion conduit and passes through an igniter/initiator 106 (e.g., a spark plug) having an operative end 108 in the interior of the segment 84.

In the exemplary embodiment, the main fuel and oxidizer are introduced to the segment 86. In the illustrated embodiment, main fuel is carried by a number of main fuel conduits 112 and main oxidizer is carried by a number of main oxidizer conduits 110, each of which has terminal portions concentrically surrounding an associated one of the fuel conduits 112 so as to mix the main fuel and oxidizer at an associated inlet 114. In exemplary embodiments, the fuels are hydrocarbons. In particular exemplary embodiments, both fuels are the same, drawn from a single fuel source but mixed with distinct oxidizers: essentially pure oxygen for the predetonator mixture; and air for the main mixture. Exemplary fuels useful in such a situation are propane, MAPP gas, or mixtures thereof. Other fuels are possible, including ethylene and liquid fuels (e.g., diesel, kerosene, and jet aviation fuels). The oxidizers can include mixtures such as air/oxygen mixtures of appropriate ratios to achieve desired main and/or predetonator charge chemistries. Further, monopropellant fuels having molecularly combined fuel and oxidizer components may be options.

In operation, at the beginning of a use cycle, the combustion conduit is initially empty except for the presence of air (or other purge gas). The predetonator fuel and oxidizer are then introduced through the associated ports filling the segment 84 and extending partially into the segment 86 (e.g., to near the midpoint) and advantageously just beyond the main fuel/oxidizer ports. The predetonator fuel and oxidizer flows are then shut off. An exemplary volume filled the predetonator fuel and oxidizer is 1-40%, more narrowly 1-20%, of the combustion conduit volume. The main fuel and oxidizer are then introduced, to substantially fill some fraction (e.g., 20-100%) of the remaining volume of the combustor conduit. The main fuel and oxidizer flows are then shut off. The prior introduction of predetonator fuel and oxidizer past the main fuel/oxidizer ports largely eliminates the risk of the formation of an air or other non-combustible slug between the predetonator and main charges. Such a slug could prevent migration of the combustion front between the two charges.

With the charges introduced, the spark box is triggered to provide a spark discharge of the initiator igniting the predetonator charge. The predetonator charge being selected for very fast combustion chemistry, the initial deflagration quickly transitions to a detonation within the segment 84 and producing a detonation wave. Once such a detonation wave occurs, it is effective to pass through the main charge which might, otherwise, have sufficiently slow chemistry to not detonate within the conduit of its own accord. The wave passes longitudinally downstream and emerges from the downstream end 30 as a shockwave within the furnace interior, impinging upon the surfaces to be cleaned and thermally and mechanically shocking to typically at least loosen the contamination. The wave will be followed by the expulsion of pressurized combustion products from the detonation conduit, the expelled products emerging as a jet from the downstream end 30 and further completing the cleaning process (e.g., removing the loosened material). After or overlapping such venting of combustion products, a purge gas (e.g., air from the same source providing the main oxidizer and/or nitrogen) is introduced through the purge port 100 to drive the final combustion products out and leave the detonation conduit filled with purge gas ready to repeat the cycle (either immediately or at a subsequent regular interval or at a subsequent irregular interval (which may be manually or automatically determined by the control and monitoring system)). Optionally, a baseline flow of the purge gas may be maintained between charge/discharge cycles so as to prevent gas and particulate from the furnace interior from infiltrating upstream and to assist in cooling of the detonation conduit.

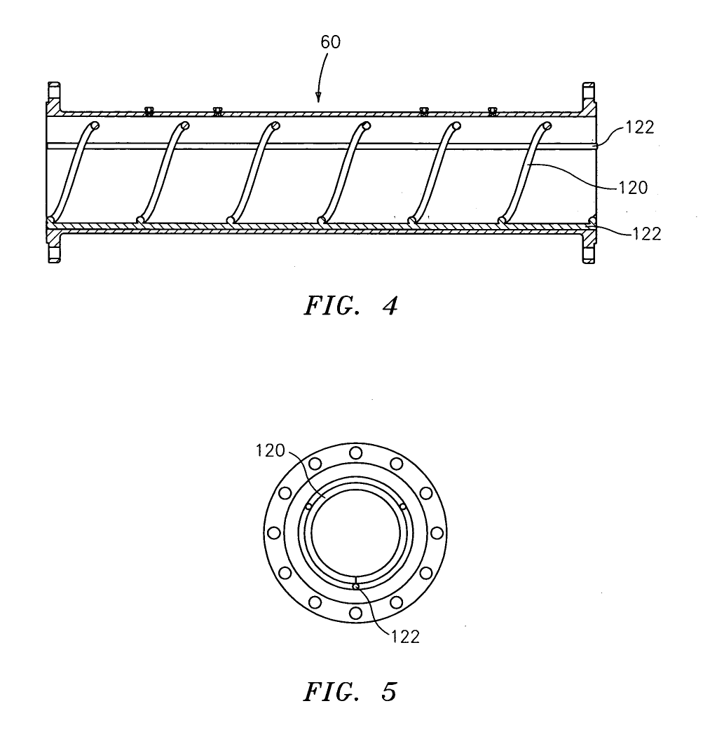

In various implementations, internal surface enhancements may substantially increase internal surface area beyond that provided by the nominally cylindrical and frustoconical segment interior surfaces. The enhancement may be effective to assist in the deflagration-to-detonation transition or in the maintenance of the detonation wave. FIG. 4 shows internal surface enhancements applied to the interior of one of the main segments 60. The exemplary enhancement is nominally a Chin spiral, although other enhancements such as Shchelkin spirals and Smirnov cavities may be utilized. The spiral is formed by a helical member 120. The exemplary member 120 is formed as a circular-sectioned metallic element (e.g., stainless steel wire) of approximately 8-20 mm in sectional diameter. Other sections may alternatively be used. The exemplary member 120 is held spaced-apart from the segment interior surface by a plurality of longitudinal elements 122. The exemplary longitudinal elements are rods of similar section and material to the member 120 and welded thereto and to the interior surface of the associated segment 60. Such enhancements may also be utilized to provide predetonation in lieu of or in addition to the foregoing techniques involving different charges and different combustor cross-sections.

The apparatus may be used in a wide variety of applications. By way of example, just within a typical coal-fired furnace, the apparatus may be applied to: the pendants or secondary superheaters, the convective pass (primary superheaters and the economizer bundles); air preheaters; selective catalyst removers (SCR) scrubbers; the baghouse or electrostatic precipitator; economizer hoppers; ash or other heat/accumulations whether on heat transfer surfaces or elsewhere, and the like. Similar possibilities exist within other applications including oil-fired furnaces, black liquor recovery boilers, biomass boilers, waste reclamation burners (trash burners), and the like.

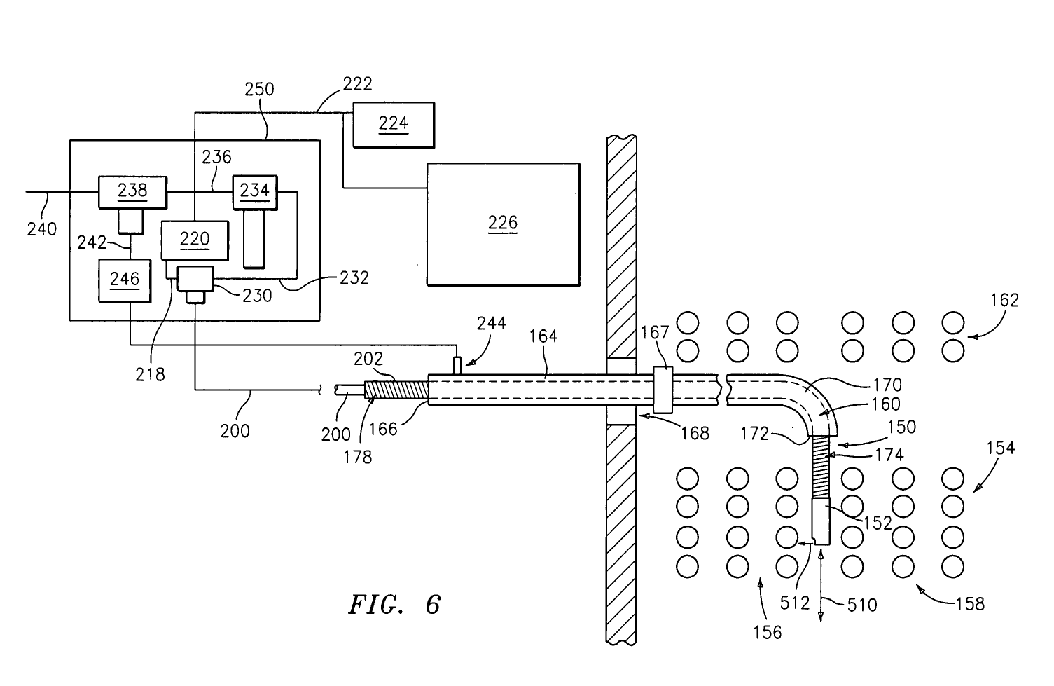

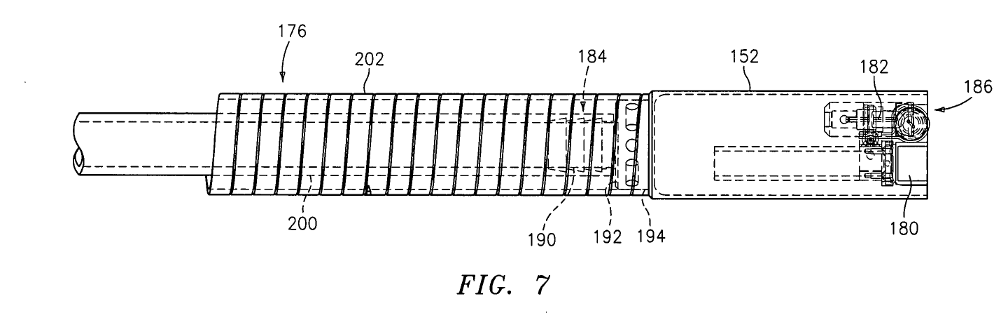

FIG. 6 shows an inspection camera apparatus 150 positioning an inspection camera head 152 within a tube bundle 154 inside the furnace. In the illustrated embodiment, the camera head is positioned between subbundles 156 and 158 of the bundle 154 via an arm 160. The exemplary arm extends between the first bundle 154 and a second bundle 162. In the exemplary embodiment, the arm 160 comprises a structural tube having a main elongate essentially straight length 164 extending from a first end 166 outside the furnace, through an aperture 168 in the furnace wall, and to a curved portion 170. The exemplary arm is formed in two main segments joined by a coupler 167. The curved portion extends to a second end 172 from which the head extends supported by a protruding downstream end portion 174 of a flexible support core 176. The exemplary support core passes through the length of the arm 160 with an upstream end portion 178 protruding from the arm first end 166. From beyond the first end 166, the support core may be inserted further into or retracted further from the arm to bring the head away from and back toward the end 172 by reciprocal movement along an axis 510 of the end and head. The support core may be rotated and may rotate the head about such axis. Furthermore, additional mechanisms (not shown) may be provided to articulate the head relative to an axis transverse to the extension axis 510. Within the exemplary head 152 (FIG. 7) there may be a camera unit 180 and a light source 182. The camera may be a CCD-type camera with one or more light filters for selectively passing a desired light range (e.g., IR, visible, or frequency bands associated with given radical species such as CH and OH).

The exemplary head 152 comprises a housing in the form of a metallic outer sleeve extending from an upstream end 184 to a downstream end 186. In the exemplary embodiment, the camera and light are aimed in a direction 512 transverse to the direction 510. An upstream end portion of the housing is formed by a hose barb 190 extending from end plate 192 of a reduced diameter portion 194. In the exemplary embodiment, the support core 176 includes a flexible hose 200 extending from an upstream end at the core upstream end to a downstream end secured to the hose barb 190. The core further includes a flexible protective jacket 202 extending from an upstream end at the core upstream end to a downstream end engaging the reduced diameter portion 194. An exemplary protective jacket 202 is formed by a metallic coil. In the exemplary embodiment, the hose carries signal/power lines 218 for the camera and light. The lines 218 extend from a camera and light control circuit 220. The control circuit 220 may have output lines 222 to an external component such as a digital video recorder 224 and monitor 226. Additional power and control inputs (not shown) may be provided. The upstream end of the hose is connected to a tee fitting 230 which receives the lines 218 and a coolant input line 232. The coolant input line passes a first coolant downstream through the hose and into the head for discharge from the head so as to cool the hose and head. The exemplary coolant is air received from a vortex chiller 234 upstream of the tee 230. The chiller is fed by a supply line 236 which, in turn, is fed from a first branch of a tee 238 coupled via supply line 240 to a source such as the shop air described above. In the exemplary embodiment, a second branch of the tee is coupled by a line 242 to an input port 244 on the arm 160, near the upstream end thereof. In the exemplary embodiment, a pressure regulator 246 is located within the line 242. The line 242 delivers a second coolant in the form of relatively unchilled air to the annular space between the arm interior surface and protective jacket exterior. Air flows downstream through that space, cooling the arm, and is discharged from the arm downstream end. In the exemplary embodiment, the tees, chiller, control circuit, pressure regulator, and related signal and fluid lines are prepackaged in a single transportable module 250. An exemplary module is a lid or other portion of a shipping case which has interior space for accommodating the recorder, monitor, control/input devices, head and coiled support core, and disassembled arm.

Dimensionally, exemplary assembled arm lengths are 2-6 m, more narrowly, 3-4 m. The exemplary head has an extension/retraction range of movement of 0.5-2.0 m, more narrowly, 1.0-1.5 m. The exemplary rotational range of motion is an infinite range. However, a limited 360° range is functionally equivalent but less convenient. Smaller ranges may, however, be used. Exemplary arm exterior diameters are 3-8 cm, more narrowly, 4-6 cm. An exemplary head diameter is 2.0-4.0 cm, with the protective jacket diameter being approximately similar (slightly less in the illustrated embodiment). Exemplary hose diameters are 1.5-2.5 cm. Exemplary coolant flows are effective to maintain operation of the camera and light and integrity of the arm and support core at operating temperatures of 800° F. or greater. An exemplary range for furnaces is 1000° F.-2500° F.

One or more embodiments of the present invention have been described. Nevertheless, it will be understood that various modifications may be made without departing from the spirit and scope of the invention. For example, the invention may be adapted for use with a variety of industrial equipment and with variety of soot blower technologies. Aspects of the existing equipment and technologies may influence aspects of any particular implementation. Accordingly, other embodiments are within the scope of the following claims.

1. An apparatus for cleaning a surface within a vessel having a vessel wall separating a vessel exterior from a vessel interior and having a wall aperture, the apparatus comprising:
an elongate conduit having an upstream first end and a downstream second end and positioned to direct a shockwave from the second end into the vessel interior; and
an inspection camera apparatus comprising:
a head held in an operative position within the vessel interior;
a light source, at least a light emitting element of said source carried by the head; and
a camera, at least an incident lens of said camera carried by the head so as to capture light from said source as returned by said surface.

2. The apparatus of claim 1 further comprising:
a source of fuel and oxidizer coupled to the conduit to deliver the fuel and oxidizer to the conduit; and
an initiator positioned to initiate a reaction of the fuel and oxidizer to produce the shockwave.

3. The apparatus of claim 1 wherein:
the camera is carried essentially within the head; and
the light source is carried essentially within the head.

4. The apparatus of claim 1 wherein the camera apparatus further comprises:
a cooling fluid-carrying support member.

5. The apparatus of claim 1 wherein:
the support member has a main portion and a distal portion at least partially transverse thereto.

6. The apparatus of claim 1 wherein:
the surface is an exterior surface of at least one tube in a first tube bundle;
the support member extends between the first tube bundle and a second tube bundle; and
the head is positioned between first and second tubes of the first tube bundle.

7. An inspection camera apparatus comprising:
a head held in an operative position within the vessel interior;
a light source, at least a light emitting element of said source carried by the head;
a camera, at least an incident lens of said camera carried by the head so as to capture light from said source as returned by said surface;
a support mechanism for holding the head in an operative position; and
a cooling fluid flowpath at least partially through the support mechanism.

8. The apparatus of claim 7 wherein:
the camera is a CCD camera.

9. The apparatus of claim 7 wherein:
the support mechanism includes main portion and a distal portion essentially normal thereto.

10. The apparatus of claim 9 wherein:
support mechanism contains lines carrying signal communication from the camera and power to the light source, the lines being cooled by the cooling fluid.

11. The apparatus of claim 7 used in combination with a detonative cleaning apparatus.

12. A method for cleaning a surface within a vessel of a piece of industrial equipment, the vessel having a wall with an aperture therein, the method comprising:
introducing fuel and oxidizer to a conduit;
initiating a reaction of the fuel and oxidizer so as to cause a shockwave to impinge upon the surface; and
using a camera having an integral light source within the vessel to inspect the surface while the industrial equipment is in operation.

13. The method of claim 12 performed in a repeated sequential way.

14. The method of claim 12 further comprising:
cooling a camera head.

15. The method of claim 12 further comprising:
inserting the camera between adjacent first and second tube bundles and then between first and second tubes of the first bundle.
